(19) United States
(12) Patent Application Publication
(10) Pub. No.: US 2006/0069600 A1
(43) Pub. Date: Mar. 30, 2006

(54) Date calculator

(75) Inventor: Jamie Ricardo Massang, Milton (AU)

Correspondence Address: YOUNG & THOMPSON, 745 SOUTH 23RD STREET, 2ND FLOOR, ARLINGTON, VA, 22202, US

(73) Assignee: PIPERPAT DOT COM LIMITED, Auckland (NZ)

(21) Appl. No.: 11/232,931

(22) Filed: Sep. 23, 2005

(30) Foreign Application Priority Data
Sep. 24, 2004 (NZ) 535551

(51) Int. Cl. G05B 19/418

(52) U.S. Cl. 705/8

(57) ABSTRACT

A date calculator for calculating significant dates associated with processing of an intellectual property comprising, a display having a plurality of columns. The columns having a series of significant dates associated with the processing. A sliding portion having one column where significant events in the processing are listed and a vertical window in the sliding portion enabling the events in a column to be exposed adjacent to the listed events.

### FIELD OF THE INVENTION

This invention relates to a device for use in calculating significant dates in the processing or prosecuting an application for the protection of registerable intellectual property such as a patent, trademark, registered design or utility model.

### BACKGROUND OF THE INVENTION

In recent times the world has experienced an explosion in the growth of Industrial Property, in particular in the area of patents. Patent attorneys throughout the world are bombarded with continual enquiries from existing and potential clients. Questions often posed to attorneys refer to procedural steps and timeframes associated with certain applications, since there are a number of different types of protection (ie. patents, trademarks and designs) and a number of different jurisdictions, with each having particular procedural and time requirements.

In an attempt to assist patent attorneys, the device of U.S. Pat. No. 5,678,862 is a circular indicating device for indicating dates associated with international patent applications. Though many attorneys have found this device to be handy, the device is bulky and generally awkward to use. In particular, the device has up to three or more windows to align, and this can lead to confusion.

### OBJECT

It is therefore an object of the present invention to provide a device, which will go at least some way towards overcoming the foregoing disadvantages in a simple yet effective manner or which will at least provide the public with a useful choice.

### STATEMENT OF INVENTION

Accordingly, in one aspect, the invention may broadly be said to consist in a date calculator for calculating significant dates associated with processing of an intellectual property application comprising;

an elongate member having a display on at least one face of said member, having a plurality of columns, said columns having a series of significant dates associated with the processing, the dates being aligned across the columns;

a sliding portion having one column where significant events in the processing are listed, and one or more windows in the sliding portion adjacent to the listed significant events, the one or more windows being capable of selectively overlaying a column, and the listed event aligning with a significant date.

Preferably the date calculator consists of only one window in the sliding portion.

Preferably the date calculator is for processing of intellectual property for a patent.

Alternatively the date calculator is for processing of a patent via the Patent Cooperation Treaty (PCT).

Preferably the date calculator consists of a list of significant events including priority documents lodging, and/or publication of document, and/or translation of priority documents, and/or demand for examination, and/or establishment of examination report, and/or 20 month period to enter into National phase, and/or 30 month period to enter into National Phase.

Preferably the date calculator display includes a reverse face which lists countries that are a 20 month National Phase entry, and/or a list of countries that are 30 month National Phase entry.

Preferably the date calculator is for processing of intellectual property for a trademark.

Preferably the processing of the trademark is via the Madrid Agreement and/or the Madrid Protocol.

Preferably the processing of intellectual property is for a design.

Preferably the processing of the designs is via the Hague Agreement.

Preferably the date calculator is used as promotional device, and may also display the sponsor's details and/or a web site, and/or other information.

A method of calculating significant dates associated with processing of an intellectual property comprising;

a display having a plurality of columns, each said columns having a series of significant dates associated with the processing;

a sliding portion having of one column where significant events in the processing are listed, and a window adjacent to the listed significant events.

wherein a user aligns the slide into position with the display by aligning the first significant event with the corresponding significant date, thus calculating the dates associated with the following listed significant events in the processing.

Preferably the first significant event and the first significant date corresponds to the priority date of the application.

Preferably processing of intellectual property is for a patent.

Preferably processing of the patent is via the Patent Cooperation Treaty (PCT).

Preferably processing of intellectual property is for a trademark.

Preferably processing of the designs is via the Madrid Agreement and/or the Madrid Protocol.

Preferably processing of intellectual property is for a design.

Preferably processing of the designs is via the Hague Agreement.

This invention may also broadly be said to consist in the parts, elements and features referred to or indicated in the specification of the application, individually or collectively, and any or all combinations of any two or more of the parts, elements or features, and where specific integers are mentioned herein which have known equivalents such equivalents are deemed to be incorporated herein as if individually set forth.

### DRAWINGS DESCRIPTION

Examples of the invention will now be described with reference to the accompanying drawings in which,

FIG. 1 is a plan view of a schematic date calculator showing the relationship of the columns of dates for a PCT date calculator.

FIG. 2 is a plan view of the schematic date calculator in use.

FIG. 3 is a plan view of a date calculator containing specific dates with the slider on the left.

FIG. 4 is a plan view of a date calculator of FIG. 4 but with the slider moved to the column for September 205.

FIG. 5 is a perspective view of a date calculator shaped as triangular prism.

### DETAILED DESCRIPTION

### EXAMPLE 1

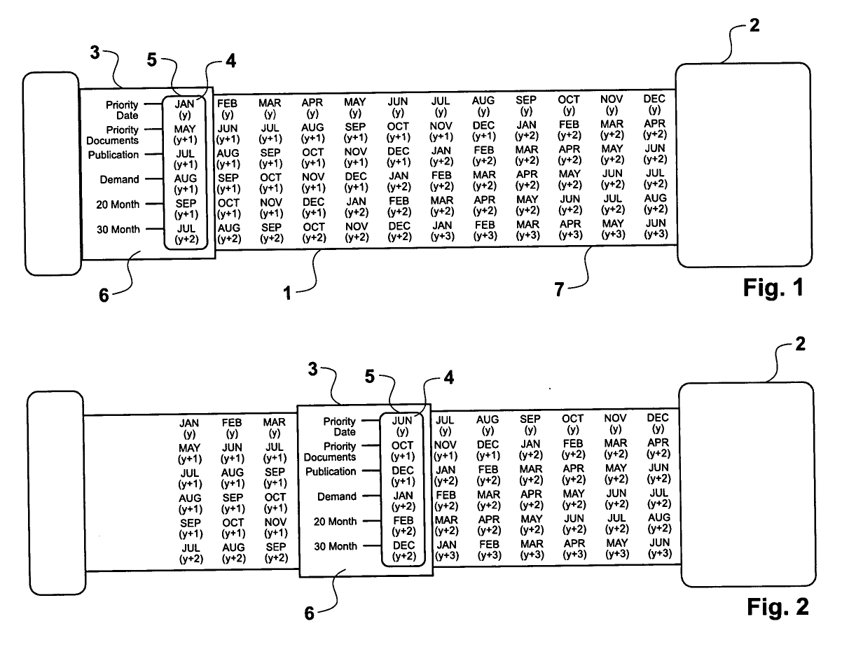

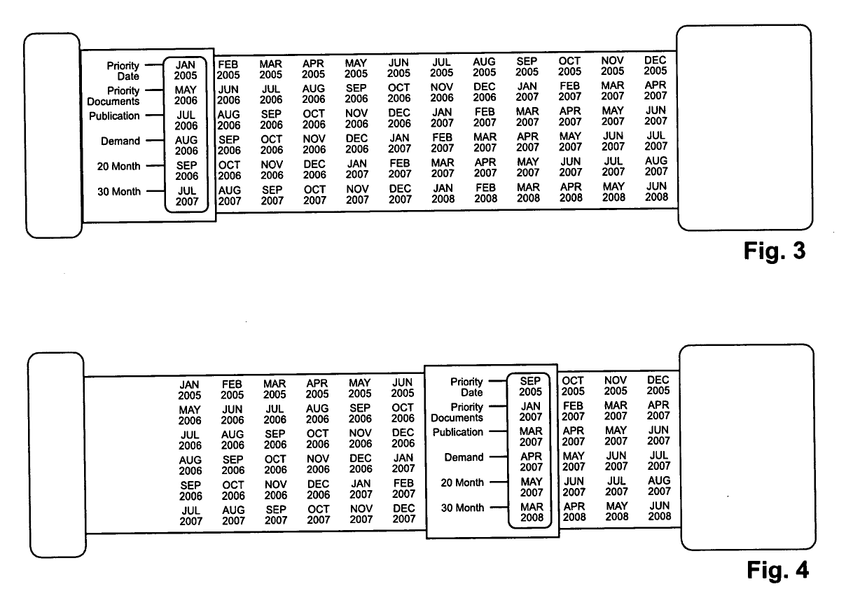

FIG. 1 illustrates one form of the invention, in particular an embodiment of the date calculator 1, which can be used in calculating significant dates in the processing of a patent via the PCT process. This first version is a generic version which allows the user to choose the year (y) and then readily calculate the subsequent years as (y+1), and (y+2). However the version shown in FIG. 3 has the years pre-printed for ease of use.

The date calculator comprises a display 2 having a number of columns 4, each column having a header that represents a month in the year, ie. January to December. As shown in FIG. 1, the preferred shape of the display is substantially rectangular with a narrowing of the mid-section 7. Though this particular embodiment uses a rectangular shaped display, other shapes such as a square and circular shape could be used as the display.

A sliding portion 3 that includes a window 5 and a list of significant events 6 in a PCT application. The first significant event is the priority date, other events that could be listed include the priority documents (lodgement of the priority document to the designated PCT office), the publication of the documents and details of the application (specification and claims), the demand for an international preliminary examination, 20-months entry into National Phase and 30-months entry into National Phase. Though FIG. 1 illustrates one list of significant events associated with a PCT application, it can be appreciated that other events in the process associated with a PCT application can be listed and the scope of the invention is not restricted by this particular embodiment.

The sliding portion 3 is attached to the display 2 by providing a collar around the narrow mid-section 7 of the display 2; this allows the sliding portion 3 to traverse across the display 2.

Variations of the attachment means could include use of channel or a sleeve.

The date calculator as depicted in FIG. 1, illustrates that the date calculator could be used in conjunction with promotional and advertising campaigns. Specifically, attorney firms can self promote by placing logos and details of the firm upon the display of the date calculator.

FIG. 2 illustrates a method of performing the invention. When compared to FIG. 1, the sliding portion has been translated horizontally across the display, such that the window highlights JUN. In this particular example a PCT application which has a priority date within June, for example a priority date of 10 Jun. 2004, then the publication of the application would occur on the 10 Dec. 2005.

### EXAMPLE 2

In another embodiment associated with the invention, the reverse face of the display may detail other supplementary information which a user may regard as useful. Possible supplementary information may include a list of 20-months National Phase jurisdictions, 30-months National Phase jurisdictions and associated costs for National Phase entries.

### EXAMPLE 3

In this example, illustrated in figures three and four, a prototype date calculator is shown printed onto cardboard and laminated. In FIG. 3 the slider is positioned to the left showing the column of dates January 2005, May 2006, July 2006, August 2006, September 2006, and July 2007. Some of the names of the months have been abbreviated to enable them to be legible and fit within the confines of each column of print, which we have set at four characters to match the width of each year. Thus along the top row the priority date is shown by month and year, and in this example the year is the year 2005.

To assist in distinguishing each row of dates, the different rows are preferably printed in different colours. For example, in a preproduction prototype in the priority date row is printed in black, the data of filing the priority documents is printed in the yellow, the date for publication is printed in a dark blue, the date for filing the demand is printed in green, the 20 month deadline is printed in red and the 30 month deadline is printed in blue. The corresponding wording on the slider is also printed in the same colour as the dates in the corresponding row. Thus the words “priority date” are printed in black and the words “30 month” are printed in light blue to coincide with the colour of the dates in the row visible in that part of the window.

In this prototype the slider is folded over the body of the date calculator, and fastened in place, so that the slider can move from left to right along the body of the date calculator but cannot escape the enlarged ends which in this prototype are shown in a different colour with the words “PCT date calculator” shown at the left hand in and the Pipers logo and the word “prototype” shown at the other end.

In FIG. 4 the slider is moved towards the right hand end of the body of the date calculator so that the window in the slider coincides with the priority date September 2005. It will be apparent that the dates visible in the window are easy to read and easily aligned with the wording associated with that particular event printed on the face of the slider.

### EXAMPLE 4

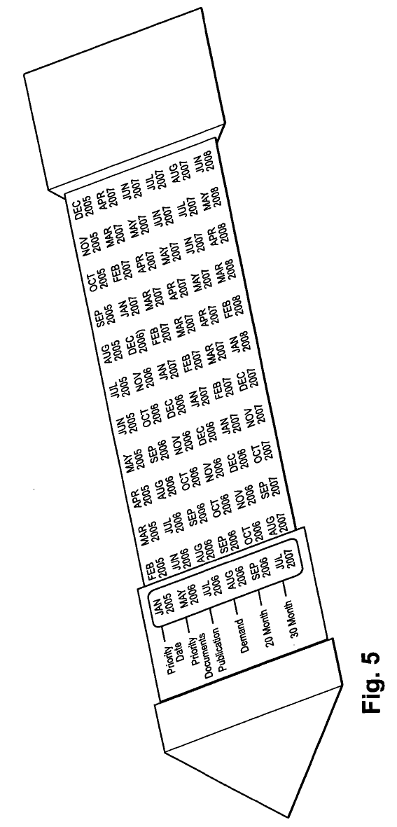

FIG. 5 illustrates a triangular date calculator folded from card or printed plastic material and assembled together so that the date calculator has three printed faces, and is in the form of a triangular prism. This enables different dates to be printed on each face, or alternatively, one face may have the dates printed in English, another face may have the dates printed in Chinese, and another face may have the dates printed in Spanish.

### ADVANTAGES

The date calculator of this invention is easy to use, as the dates can be easily lined up in the vertical window of the slider. By choosing a date in the top row, it is possible to read off the relevant dates for that PCT application by reading the dates visible in the one or more windows of the slider. In the case of a flat, i.e. essentially two-dimensional date calculator, it can be easily produced by printing, and can be easily distributed by post. This two-dimensional slide is not bulky, fitting easily inside an envelope, or easily stored in a bag or briefcase.

### VARIATIONS

The dates can be printed on one or both faces in the same or different languages. It can be produced in the form of a prism with a plurality of faces (although for simplicity and ease of use we prefer the two dimensional version printed with different languages on the two faces thereof.

Though the illustrated embodiments referred to patents and PCT applications, it will be appreciated that the date calculator could be used in trademarks applications in conjunction with the Madrid Agreement and/or Madrid Protocol. In addition the date calculator could be used in designs applications in conjunction with the Hague Agreement.

Thus it can be seen that the date calculator as described provides a simple and straightforward means in calculating dates associated with prosecuting intellectual property. The date calculator only requires aligning one event with one date with the remaining required information calculated and displayed. Furthermore, the date calculator has other practical uses such as a ruler, and/or a bookmark, and/or marker. Since the configuration is simple and practical, storing the device is easy.

Instead of one window in the slide there may be a plurality of smaller windows one above the other so as to align with each date in the column. The date calculator may be double or multiple sided, triangular or rectangular in cross section if multiple displays are required.

Instructions on how to operate the date calculator can be printed on the reverse of the body of the rule.

It is also proposed that the date calculator will contact a link to a web site that provides an automated reminder service, preferably one which will remind a user of dates specific to a particular pending intellectual property application. An example of this is a link to a site that provides email or other communication reminders to a user of the dates associated with a PCT application.

Throughout the description and claims of this specification the word “comprise” and variations of that word, such as “comprises” and “comprising”, are not intended to exclude other additives, components, integers or steps.

Finally various other modifications or alterations can be made to the foregoing without departing form the scope of the invention set forth in the claims.

1. A date calculator for calculating significant dates associated with processing of an intellectual property comprising;
an elongate member having a display on at least one face of said member, having a plurality of columns, said columns having a series of significant dates associated with the processing, the dates being aligned across the columns;
a sliding portion having one column where significant events in the processing are listed and one or more windows in the sliding portion adjacent to the listed significant events, the one or more windows being capable of selectively overlaying a column, and the listed event aligning with a significant date.

2. A date calculator according to claim 1, wherein there is only one window in the sliding portion.

3. A date calculator according to claim 1, wherein the significant dates are associated with the processing of intellectual property for a patent.

4. A date calculator according to claim 3, wherein the significant dates and events are associated with the processing of a patent via the Patent Cooperation Treaty (PCT).

5. A date calculator according to claim 1, wherein the list of significant events include priority documents lodging, and/or publication of document, and/or translation of priority documents, and/or demand for examination, and/or establishment of examination report, and/or 20-month period to enter into National Phase, and/or 30-month period to enter into National Phase.

6. A date calculator as claimed in claim 1, wherein the elongate member is substantially flat and has to main faces each face having a plurality of columns printed thereon.

7. A date calculator as claimed in claim 1, wherein the elongate member is in the form of a prism having three or more faces any one or more of which has a plurality of columns displayed thereon.
